(19) United States
(12) Patent Application Publication
(10) Pub. No.: US 2013/0025376 A1
(43) Pub. Date: Jan. 31, 2013

(54) Wind-Speed-Detecting Device

(71) Applicant: Tso-Kuo Yin, Lingya Dist. (TW)

(72) Inventor: Tso-Kuo Yin, Lingya Dist. (TW)

(21) Appl. No.: 13/241,796

(22) Filed: Sep. 23, 2011

(30) Foreign Application Priority Data
Jul. 26, 2011 (TW) 100126429

(51) Int. Cl. G01F 1/56

(52) U.S. Cl. 73/861.08

(57) ABSTRACT

A wind-speed-detecting device including a stator, a rotor and a processing unit is disclosed. The stator has a flux-sensing member. The rotor has a plurality of blades and a magnet module, wherein the rotor is rotatably coupled with the stator, at least a part of the plurality of blades is arranged in a settling area of an air channel, and the magnet module faces the flux-sensing member. The processing unit electrically connects with the flux-sensing member to receive an electrical signal generated by the flux-sensing member and to send out a processing result.

### BACKGROUND OF THE INVENTION

1. Field of the Invention

The present invention generally relates to a wind-speed-detecting device and, more particularly, to a wind-speed-detecting device for detecting a speed of an airflow in an air channel.

2. Description of the Related Art

In a conventional air-conditioning system, an air conditioner can generate conditioned air and sends the air to a plurality of air outlets through air channels so as to control the condition of air in rooms of a building where the air outlets are formed. However, this conventional air-conditioning system is unable to provide any information for analysis in fault detection when the operating efficiency of the air-conditioning system is poor. In some cases where cooling efficiency of the air conditioner becomes poor, it may be because that the air conditioner is broken or the air channel of the air conditioner is blocked. Furthermore, when operating efficiency of the air-conditioning system becomes poor due to blocking of air channels, it is hard to determine which one of the air channels is blocked by air-intensity detection since there are too many air channels in the building.

Please refer to FIG. 1. A conventional wind-speed-detecting device as the invention of Taiwan Patent Publication No. 201111787 is disclosed, which is numbered as “90” and is for air-intensity detection of an air channel 91. The wind-speed-detecting device 90 has a light sensor 901 mounted in a dark container 911, with a shelter plate 912 arranged between the dark container 911 and the air channel 91 and a light source 913 adjacent to the shelter plate 912. When an air current flows in the air channel 91, the shelter plate 912 can be lifted and rotated by an angle for the light emitted by the light source 913 to go through a slit formed between a lifted end of the shelter plate 912 and the inner surface of the dark container 911 toward the light sensor 901. Therefore, as the said slit being enlarged by an intensity-increased air current flowing in the air channel 91, the light sensor 901 can sense stronger light passing through the enlarged slit for the wind-speed-detecting device 90 to estimate the intensity of the air current.

In practical operation, the lifted shelter plate 912 has to recover its position by a recovering force once the air current is stopped since the wind-speed-detecting device 90 is designed to continuously detect the intensity of the air current. However, when the air current is too weak to move the shelter plate 912 against the recovering force to form the slit, the wind-speed-detecting device 90 is unable to detect the intensity of the air current. On the other hand, when the intensity of the air current is strong enough to move the shelter plate 912 in a position exposing the whole cross section of the air channel 91, the wind-speed-detecting device 90 can only show a largest intensity value even if the intensity of the air current further increases. In light of this, it is desired to improve the conventional wind-speed-detecting device.

### SUMMARY OF THE INVENTION

It is therefore the primary objective of this invention to provide a wind-speed-detecting device in order to monitor the operation of an air-conditioning system.

It is therefore another objective of this invention to provide a wind-speed-detecting device with a larger detecting range and an accurate result.

The invention discloses a wind-speed-detecting device comprising a stator, a rotor and a processing unit. The stator has a flux-sensing member. The rotor has a plurality of blades and a magnet module, wherein the rotor is rotatably coupled with the stator, at least a part of the plurality of blades is arranged in a settling area of an air channel, and the magnet module faces the flux-sensing member. The processing unit electrically connects with the flux-sensing member to receive an electrical signal generated by the flux-sensing member and to send out a processing result.

The invention further discloses that the settling area is arranged at an air outlet of the air channel.

The invention further discloses that the settling area is arranged at an air inlet of the air channel.

The invention further discloses that the flux-sensing member includes a silicon steel module, a coil module and an electrical connector, with the coil module electrically connecting with the electrical connector.

The invention further discloses that the processing result generated by the processing unit is a wind speed value of an air current passing through the air channel.

The invention further discloses that the processing unit includes a power-supplying unit, a signal transformer and a monitor, the power-supplying unit and the signal transformer both electrically connect with the flux-sensing member, and the signal transformer electrically connects with the monitor.

The invention further discloses that the processing unit includes a power-supplying unit, a signal transformer and a signal transmitter, the power-supplying unit and the signal transformer both electrically connect with the flux-sensing member, and the signal transformer electrically connects with the signal transmitter.

### BRIEF DESCRIPTION OF THE DRAWINGS

The present invention will become more fully understood from the detailed description given hereinafter and the accompanying drawings which are given by way of illustration only, and thus are not limitative of the present invention, and wherein:

FIG. 1 shows a cross-sectional view of a conventional wind-speed-detecting device.

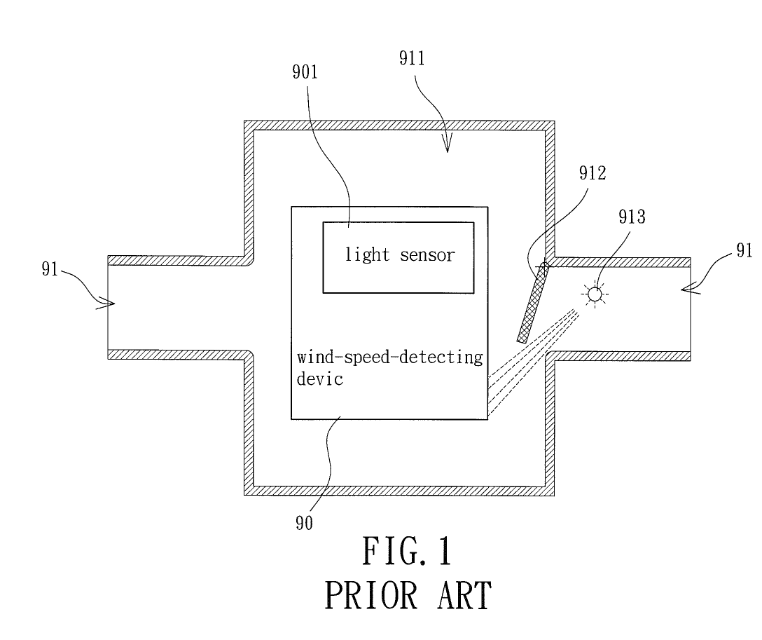

FIG. 2 shows a structure diagram of a wind-speed-detecting device according to a first embodiment of the invention.

FIG. 3 shows a structure diagram of a wind-speed-detecting device according to a second embodiment of the invention.

In the various figures of the drawings, the same numerals designate the same or similar parts. Furthermore, when the term “first,” “second,” and similar terms are used hereinafter, it should be understood that these terms refer only to the structure shown in the drawings as it would appear to a person viewing the drawings, and are utilized only to facilitate describing the invention.

### DETAILED DESCRIPTION OF THE INVENTION

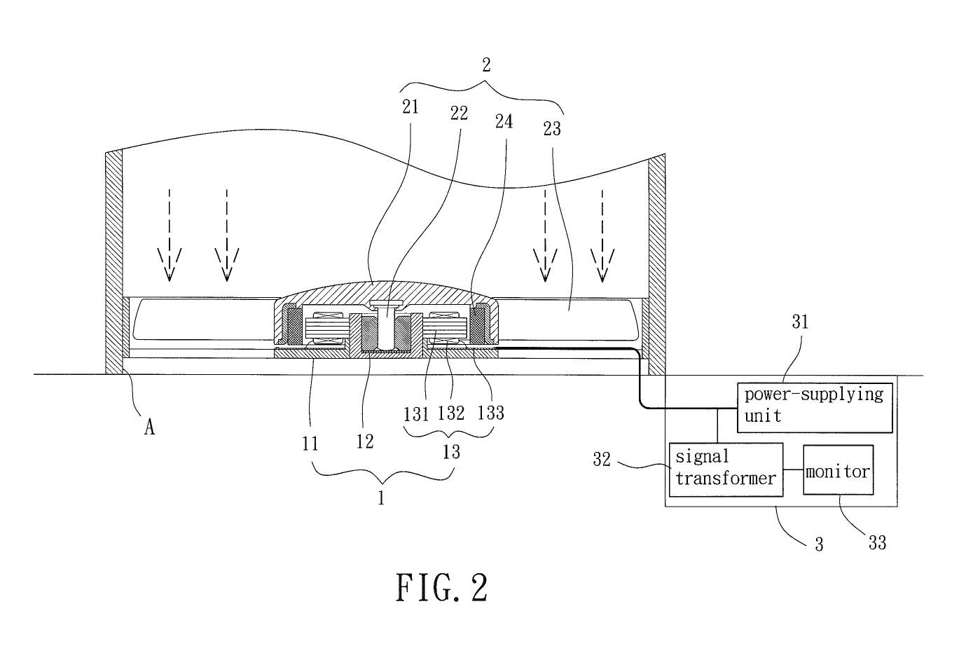

Referring to FIG. 2, a first embodiment of the present invention including a stator 1, a rotor 2 and a processing unit 3 is shown. The rotor 2 is rotatably coupled with the stator 1 as well as the processing unit 3 electrically connects with the stator 3.

The stator 1 has a base 11 with a bearing 12 and a flux-sensing member 13 mounted on the base 11. The flux-sensing member 13 includes a silicon steel module 131, a coil module 132 and an electrical connector 133, wherein the coil module 132 electrically connects with a first end of the electrical connector 133 for the electrical connector 133 to receive an electrical signal generated by the coil module 132.

The rotor 2 has a hub 21 with a shaft 22, and the shaft 22 is rotatably coupled with the bearing 12 of the stator 1, so that the rotor 2 is coupled with the stator 1 and able to rotate relative to the stator 1. There is a plurality of blades 23 formed on the hub 21, while at least a part of the plurality of blades 23 is arranged in an air channel. Although a settling area of the air channel wherein the blades 23 are disposed can be formed in any suitable position of the air channel, it is preferable to arrange the settling area at an air inlet of the air channel or at an air outlet “A” of the air channel as shown in FIG. 2. A magnet module 24 is arranged on an inner circumferential wall of the hub 21, with a magnetic flux of the magnet module 24 passing through the flux-sensing member 13 of the stator 1. Therefore, the magnetic flux passing through the coil module 132 of the flux-sensing member 13 changes when the magnet module 24 rotates with the hub 21, and the changing magnetic flux can generate an electrical signal in the coil module 132 due to back electromotive force (back-EMF), so that the electrical connector 133 can receive and send out the electrical signal.

Specifically, in accordance with FIG. 2, when an air current is expelled by the air outlet “A,” the air current also goes through the settled area wherein the blades 23 of the rotor 2 is arranged since the settled area is at the air outlet “A.” Front faces of the blades 23 preferably face the source where the air current comes towards the air outlet “A” for the blades 23 to be pushed by the air current and thus the rotor 2 can be rotated relative to the stator 1. Accordingly, the magnet module 24 of the rotor 2 also rotates relative to the flux-sensing member 13 of the stator 1, and thus the magnetic flux passing through the coil module 132 changes and generates the electrical signal which is sent to the electrical connector 133.

The processing unit 3 is able to receive the electrical signal, determine the back-EMF corresponding to the electrical signal, calculate a rotational speed of the rotor 2, estimate a current speed of the air current driving the rotor 2, and output a processing result corresponding to the current speed. Please be noted that the electrical signal can be in the form of voltage, current or any other form of signal, and the processing result may be a wind speed degree or a wind speed value representing the current speed. However, the forms of the electrical signal and the processing result are not limited thereby.

The processing unit 3 can be a local processor only connecting with an electrical connector 133 of a stator 1. However, the processing unit 3 can also be a central processor connecting with a plurality of electrical connectors 133 of plural stators 1 so as to simultaneously handle the electrical signals thereof. In this embodiment shown in FIG. 2, the processing unit 3 is a local processor that only handles the electrical signal of a single stator 1 detecting the current speed of the current passing through a single air outlet “A.”

Referring to FIG. 2 again, in this first embodiment, the processing unit 3 includes a power-supplying unit 31, a signal transformer 32 and a monitor 33. The power-supplying unit 31 and the signal transformer 32 both electrically connect with a second end of the electrical connector 133, and the signal transformer 32 electrically connects with the monitor 33. The power-supplying unit 31 can receive the electrical signal of the coil module 132 through the electrical connector 133, store the power within the electrical signal, and supply the devices of the processing unit 3 with the stored power. The signal transformer 32 can also receive the electrical signal of the coil module 132 through the electrical connector 133. The signal transformer 32 will determine the back-EMF, calculate the rotational speed of the rotor 2, estimate the current speed of the air current passing through the air outlet “A,” and output the processing result to the monitor 33 once the signal transformer 32 receives the electrical signal, so as to complete the wind detecting function of this invention.

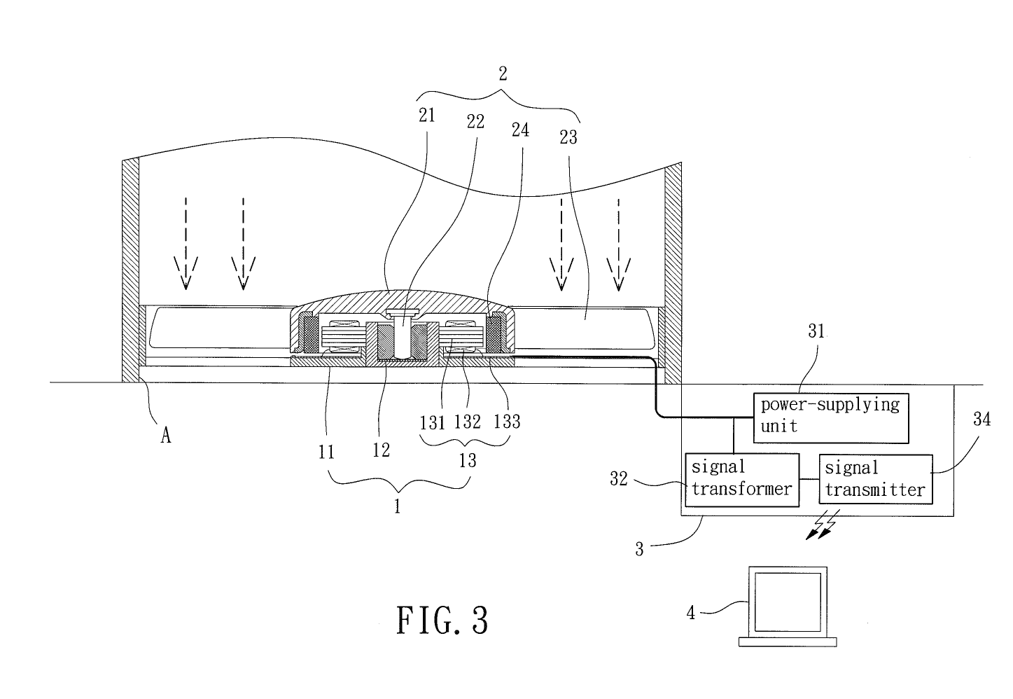

Referring to FIG. 3, a second embodiment of this invention is shown. The difference between this embodiment and the first embodiment lies in that the monitor 33 used in the first embodiment is replaced by a signal transmitter 34. Therefore, the signal transmitter 34 can wirelessly transmit the processing result to a monitor system 4 for remote users. Furthermore, the monitor system 4 can also receive plural processing results to act as a monitoring center.

Although the invention has been described in detail with reference to its presently preferable embodiment, it will be understood by one of ordinary skill in the art that various modifications can be made without departing from the spirit and the scope of the invention, as set forth in the appended claims.

What is claimed is:

1. A wind-speed-detecting device, comprising:
a stator having a flux-sensing member;
a rotor having a plurality of blades and a magnet module, wherein the rotor is rotatably coupled with the stator, at least a part of the plurality of blades is arranged in a settling area of an air channel, and the magnet module faces the flux-sensing member; and
a processing unit electrically connecting with the flux-sensing member to receive an electrical signal generated by the flux-sensing member and to send out a processing result.

2. The wind-speed-detecting device as claimed in claim 1, wherein the settling area is arranged at an air outlet of the air channel.

3. The wind-speed-detecting device as claimed in claim 1, wherein the settling area is arranged at an air inlet of the air channel.

4. The wind-speed-detecting device as claimed in claim 1, wherein the flux-sensing member includes a silicon steel module, a coil module and an electrical connector, with the coil module electrically connecting with the electrical connector.

5. The wind-speed-detecting device as claimed in claim 1, wherein the processing result generated by the processing unit is a wind speed value of an air current passing through the air channel.

6. The wind-speed-detecting device as claimed in claim 1, wherein the processing unit includes a power-supplying unit, a signal transformer and a monitor, the power-supplying unit and the signal transformer both electrically connect with the flux-sensing member, and the signal transformer electrically connects with the monitor.

7. The wind-speed-detecting device as claimed in claim 1, wherein the processing unit includes a power-supplying unit, a signal transformer and a signal transmitter, the power-supplying unit and the signal transformer both electrically connect with the flux-sensing member, and the signal transformer electrically connects with the signal transmitter.
